(19) United States
(12) Patent Application Publication
(10) Pub. No.: US 2015/0242567 A1
(43) Pub. Date: Aug. 27, 2015

(54) METHODS, APPARATUSES AND COMPUTER PROGRAM PRODUCTS FOR PROVIDING AN ANNOTATED CLINICAL DATA MANAGEMENT PROCESS

(71) Applicant: Caradigm USA LLC, Bellevue, WA (US)

(72) Inventors: Jessica Brier Smail, Kirkland, WA (US); Jay W. Daugherty, Arlington, VA (US); Jennifer Ann Crandall, Kent, WA (US); Linda Renee Walmer, Seattle, WA (US)

(73) Assignee: Caradigm USA LLC, Bellevue, WA (US)

(21) Appl. No.: 14/186,830

(22) Filed: Feb. 21, 2014

(51) Int. Cl. G06F 19/00

(52) U.S. Cl. CPC G06F 19/322

(57) ABSTRACT

An apparatus is provided for managing clinical information. The apparatus may include at least one memory and at least one processor configured to automatically receive one or more items of clinical information, corresponding to respective patients, from different sources. The processor is also configured to detect an indication of a comparison indicating whether medications identified in the clinical information were utilized by the patients as prescribed by a health care provider(s). The processor is also configured to generate a user interface including visible indicia indicating medications prescribed to respective patients and statuses of the medications. The statuses may be designated responsive to determining that one or more respective items of the clinical information is newly received from one of the different sources or based in part on the comparison indicating whether the medications were utilized by the patients as prescribed. Corresponding computer program products and methods are also provided.

### TECHNOLOGICAL FIELD

Embodiments of the invention relate generally to a mechanism of facilitating user interaction with health care data and more particularly relate to a method, apparatus and computer program product for managing clinical data.

### BACKGROUND

Currently, as medical care becomes increasingly complex and individuals seek care from a greater number of providers and specialists, the likelihood of people taking multiple medications at one time has increased dramatically. Often, individuals do not have just one primary provider that manages all of their medications as a whole. The task of gathering information about medications and verifying that the patient is indeed taking each of these medications as well as verifying the actual dosage may be complex. Additionally, the task of gathering information about other health data such as Immunizations, and Health Issues (e.g., Problems & Diagnoses) may also be complex.

At present, a problem in the health care area involves many patients taking medications that are prescribed by different providers, and different sources. In this regard, the patient may be prescribed one medication from a first provider, and another medication from a second provider, and the first provider may not know the medication that the second provider prescribed. Because so many medications may be interacting with one another, there may be a chance that providers are prescribing medications that are potentially harmful when combined. As such, currently, the prescribed medication information of a patient(s) may be disbursed throughout the patient's care and the medication information may not be adequately coordinated or stored in one place or a central location. In this regard, there may be potential for harm to a patient taking the medications because the medications may interact in a harmful manner when combined.

Additionally, at present, many electronic medical record (EMR) systems may include modules to track medications prescribed by providers that use the EMR. In this regard, currently usage of the EMR to track medications taken by patients is typically manually added to a list of medications. However, manually adding medications to a list in an EMR system may have some drawbacks.

For example, a patient may visit their primary care doctor, and the primary care doctor may use EPIC, an in-patient EMR, to write a prescription for the patient so that the prescription is captured and stored in the EPIC system. Additionally, during the same visit, the patient may inform the primary care doctor that the patient is taking some other medication. As such, the primary care provider may enter the other medication into the EPIC system. In this manner, the primary care doctor may be able to keep a record of the patient's medications. However, consider an example in which the patient forgets that the patient is taking yet another medication and does not inform the primary care doctor of this other medication. In this regard, there may be medication information pertaining to the patient that is not stored in one place or in a central location and as such all of the medication information of the patient may not be apparent to care providers of the patient.

In view of the foregoing drawbacks, there may be a need for an efficient and reliable mechanism to manage clinical information of patients across the continuum of care of the patients.

### BRIEF SUMMARY

A method, apparatus and computer program product are therefore provided that may provide an efficient and reliable mechanism of managing clinical information of one or more patients. In this regard, an example embodiment may assist health care providers in the task of managing patient medications by collecting and collating information about all medications of patients, supporting a review process by which a health care provider(s) may verify the medication(s) and the dosage being taken by a patient(s), and displaying a current list of active medications detailing any deviations in usage of the medications or special instructions.

Additionally, an example embodiment may collect and analyze other clinical data, including but not limited to, health issues (e.g., health problems, medical diagnoses, etc.), immunizations, vitals and other suitable clinical data received by a system (e.g., a health care system) from different sources (e.g., different health care entities) to provide a complete view of the clinical data (e.g., medication information, health issues (e.g., health problems, medical diagnoses, etc.), immunizations, vitals, etc.) of one or more patients. Moreover, an example embodiment may enable a user (e.g., a care manager, a health care professional, etc.) to augment the clinical data with their own findings and thoughts. For instance, an example embodiment may enable a user (e.g., a care manager, a health care professional, etc.) to determine the manner in which a patient(s) is currently taking a medication(s) by comparing actual usage of a corresponding medication by the patient versus the prescribed medication as well as the filled medication. In this regard, an example embodiment may track clinical data and provide auditing of clinical data received from different sources (e.g., different health care entities) versus clinical data that was added or annotated by a user (e.g., a care manager, a health care professional, etc.).

In one example embodiment, a method for managing clinical information is provided. The method may include automatically receiving one or more items of clinical information, corresponding to one or more respective patients, from a plurality of different sources. The method may further include detecting an indication of a comparison indicating whether one or more medications identified in the clinical information were utilized by the patients as prescribed by at least one health care provider. The method may further include generating a user interface including visible indicia indicating corresponding medications prescribed to respective patients and respective statuses of the corresponding medications. The statuses may be designated in response to determining that one or more respective items of the clinical information is newly received from one of the different sources or based in part on the comparison indicating whether the medications were utilized by the patients as prescribed.

In another example embodiment, an apparatus for managing clinical information is provided. The apparatus may include a processor and a memory including computer program code. The memory and computer program code are configured to, with the processor, cause the apparatus to at least perform operations including automatically receiving one or more items of clinical information, corresponding to one or more respective patients, from a plurality of different sources. The memory and computer program code are also configured to, with the processor, cause the apparatus to detect an indication of a comparison indicating whether one or more medications identified in the clinical information were utilized by the patients as prescribed by at least one health care provider. The memory and computer program code are also configured to, with the processor, cause the apparatus to generate a user interface including visible indicia indicating corresponding medications prescribed to respective patients and respective statuses of the corresponding medications. The statuses are designated in response to determining that one or more respective items of the clinical information is newly received from one of the different sources or based in part on the comparison indicating whether the medications were utilized by the patients as prescribed.

In another example embodiment, a computer program product for managing clinical information is provided. The computer program product includes at least one computer-readable storage medium having computer-executable program code instructions stored therein. The computer-executable program code instructions may include program code instructions configured to automatically receive one or more items of clinical information, corresponding to one or more respective patients, from a plurality of different sources. The computer program product may further include program code instructions configured to detect an indication of a comparison indicating whether one or more medications identified in the clinical information were utilized by the patients as prescribed by at least one health care provider. The computer program product may further include program code instructions configured to generate a user interface including visible indicia indicating corresponding medications prescribed to respective patients and respective statuses of the corresponding medications. The statuses may be designated in response to determining that one or more respective items of the clinical information is newly received from one of the different sources or based in part on the comparison indicating whether the medications were utilized by the patients as prescribed.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a schematic block diagram of a computing device according to an exemplary embodiment of the invention;

FIGS. 4A-4N are diagrams illustrating user interfaces according to exemplary embodiments of the invention; and

FIG. 5 is a flowchart of an exemplary method according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### General System Architecture

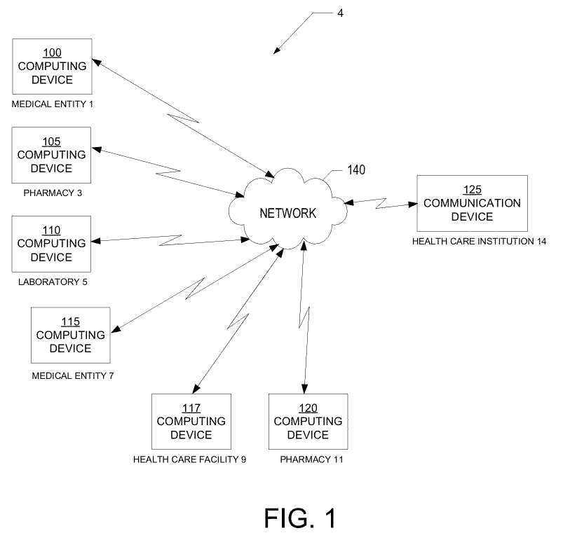

Referring now to FIG. 1, a block diagram of a system according to an exemplary embodiment is provided. As shown in FIG. 1, the system 4 (e.g., a health care system) may include one or more computing devices 100, 105, 110, 115, 117 and 120 (e.g., personal computers, laptops, tablet computing devices, workstations, servers, personal digital assistants, smart devices and the like, etc.) which may access one or more network entities such as, for example, a communication device 125 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 125 is capable of receiving data from and transmitting data to the computing devices 100, 105, 110, 115, 117 and 120 via network 140.

In one exemplary embodiment, the computing devices 100, 105, 110, 115, 117 and 120 may be utilized by clinicians (e.g., physicians, nurses, pharmacists, psychologists, social workers, physical therapists, laboratory technicians, etc.) and/or any other suitable health care professionals. The computing devices 100, 105, 110, 115, 117, 120 may be maintained by one or more health care institutions. For instance, the computing device 100 may be maintained by a medical entity 1 (e.g., a medical clinic), the computing device 105 may be maintained by a pharmacy 3, the computing device 110 may be maintained by a laboratory 5. In addition, the computing device 115 may be maintained by a medical entity 7 (e.g., a hospital), the computing device 117 may be maintained by a health care facility 9 (e.g., a psychotherapy entity (e.g., a psychiatric office, an office of a social worker, etc.) and the computing device 120 may be maintained by the pharmacy 11. In an exemplary embodiment, the communication device 125 may be maintained by a health care institution 14. The communication device 125 may be utilized by one or more health care professionals and/or clinicians such as, for example, care managers (e.g., nurses).

The communication device 125 may communicate with the computing devices 100, 105, 110, 115, 117, and 120. In this regard, the communication device 125 may receive medical information from and may transmit medical information to the computing devices 100, 105, 110, 115, 117, and 120. The medical information may be utilized by the communication device 125 to manage medication information as well as other clinical information of patients, as described more fully below.

It should be pointed out that although FIG. 1 shows six computing devices 100, 105, 110, 115, 117, 120 and one communication device 125 any suitable number of computing devices 100, 105, 110, 115, 117, 120 and communication devices 125 may be part of the system of FIG. 1 without departing from the spirit and scope of the invention.

### Communication Device

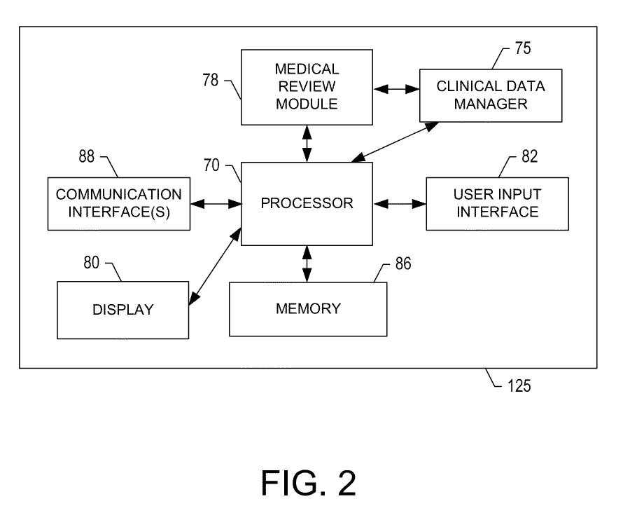

Referring now to FIG. 2, a block diagram of a communication device is provided according to an exemplary embodiment of the invention. The communication device 125 may, but need not, be a network device such as, for example, a server. The communication device 125 may include various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 125 may include a processor 70 connected to a memory 86. The memory may comprise volatile and/or non-volatile memory, and typically stores content (e.g., media content, medical information, etc.), data, information or the like.

For example, the memory may store content transmitted from, and/or received by, the computing devices 100, 105, 110, 115, 117 and 120. In this regard, in an exemplary embodiment, the memory 86 may store data received from various disparate sources. For example, the memory 86 may store medical information received by the communication device 125 from the computing devices of the medical entity 1, the pharmacy 3, the laboratory 5, the medical entity 7, the health care facility 9 and the pharmacy 11, etc. The medical information may include, but is not limited to, prescriptions, medications, medical diagnoses, medical problems, immunizations, vitals, laboratory results, medical tests or measurements, medical chart information, alert/notification data and any other suitable information.

The medical information received by the communication device 125 from the computing devices 100, 105, 110, 115, 117, 120 may include one or more patient identifiers of respective patients. For example, medical record numbers (MRNs) may be utilized as patient identifiers to identify respective patients. In addition, or alternatively, patient demographic data (e.g., biographical data (e.g., name, date of birth, etc.), race, age, gender, etc.) may be utilized to identify one or more patients.

Additionally, for example, the memory 86 typically stores client applications, instructions, algorithms or the like for execution by the processor 70 to perform steps associated with operation of the communication device 125 in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 125 may include one or more logic elements for performing various functions of one or more client applications. In an exemplary embodiment, the communication device 125 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, computing devices 100, 105, 110, 115, 117, 120 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface may support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a clinical data manager 75. The clinical data manager 75 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the clinical data manager 75, as described below. In examples in which software is employed, a device or circuitry (e.g., processor 70 in one example) executing the software forms the structure associated with such means. As such, for example, the clinical data manager 75 may be configured to, among other things, receive, aggregate and manage medical data from multiple different sources/entities such as, for example, computing devices 100, 105, 110, 115, 117, 120 maintained respectively by the medical entity 1, the pharmacy 3, the laboratory 5, the medical entity 7, the health care facility 9 and the pharmacy 11, as described more fully below.

Additionally, in an example embodiment, the processor 70 may be in communication with and may otherwise control a medical review module 78. The medical review module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the medical review module 78, as described below. In examples in which software is employed, a device or circuitry (e.g., processor 70 in one example) executing the software forms the structure associated with such means. As such, for example, the medical review module 78 may be configured to, among other things, receive data, from the clinical data manager 75, related to one or more patients for managing medication information and other clinical data pertaining to the patients being evaluated by a clinician (e.g., a care manager, a health care professional, etc.), as described more fully below.

### Computing Device

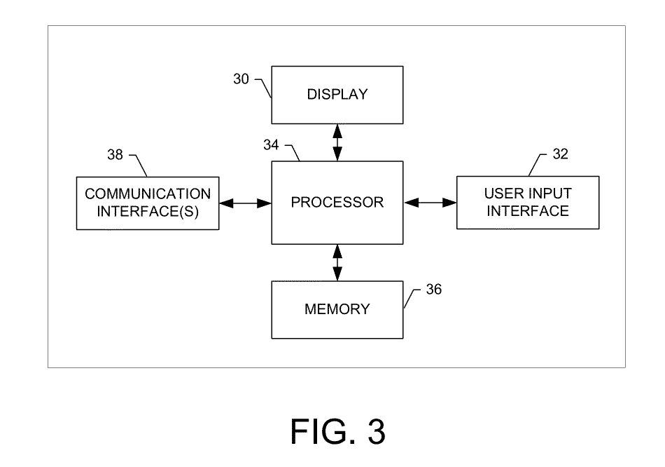

Referring now to FIG. 3, a block diagram of a computing device according to an exemplary embodiment is provided. The computing device is capable of operating as any of computing devices 100, 105, 110, 115, 117 and 120. In this regard, the computing devices 100, 105, 110, 115, 117, and 120 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. In addition, the memory device 36 may store client applications, software (e.g., software code) algorithms, instructions or the like for the processor 34 to perform steps associated with operation of the computing device.

The memory device 36 may store medical information (e.g., medications, prescriptions, medical diagnoses, immunizations, vitals, medical problems, laboratory results, medical visit information, etc.) associated with one or more patients. The medical information may include one or more patient identifiers (e.g., MRNs) identifying respective patients (e.g., Jane Doe, a fictitious patient) and/or biographic data (e.g., name, date of birth, etc.).

In an instance in which medical information of one or more of the patients is sent to the communication device 125, by the processor 34, the clinical data manager 75 of the communication device 125 may detect a patient identifier(s) (e.g., a MRN(s), biographic data, etc.) to identify respective patients and corresponding medical data (e.g., medications, prescriptions, etc.). In this manner, the clinical data manager 75 may maintain and manage data received from various sources/entities (e.g., medical entities, pharmacies, laboratories health care facilities, etc.) pertaining to one or more patients.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display or any other input device.

### Exemplary System Operation

Exemplary embodiments of the invention may provide an efficient and reliable mechanism for managing medication data and other clinical data of one or more patients. In this regard, in an exemplary embodiment the medical review module 78 may enable one or more users (e.g., clinicians, health care professionals, etc.) to designate a medication(s) or other item(s) of clinical data received from one or more disparate/different sources or entities (also referred to herein as data feeds) (e.g., medical entity 1, the pharmacy 3, the laboratory 5, the medical entity 7, the health care facility 9 and the pharmacy 11, etc.) as validated, needs review, in review or any other suitable designation.

The medication information or other clinical information received from one or more of the different sources/entities may be included with an identifier (e.g., a MRN, demographic data (e.g., biographic data (e.g., name, date of birth, etc.), etc.)) indicating a patient that corresponds to the information. In this regard, for example, in an instance in which a care provider (e.g., a physician) of an entity (e.g., medical entity 1) inputs, via an electronic device (e.g., computing device 100), a prescription for a patient, the medication information indicating the prescription for the patient may be automatically sent from the electronic device (e.g., computing device 100) and received by the medical review module 78 of the communication device 125. As another example, in an instance in which a user (e.g., a care manager, a health care professional (e.g., a pharmacist)) of an entity (e.g., pharmacy 3) inputs, via an electronic device (e.g., computing device 105), a prescription for a patient, the medication information indicating the prescription for the patient may be automatically sent from the electronic device (e.g., computing device 105) and received by the medical review module 78 of the communication device 125. In this manner, the medical review module 78 may analyze all the received clinical information (e.g., medication information (e.g., prescriptions)) and may organize and arrange each of the medications one or more patients are taking. As such, the medical review module 78 may group the medications corresponding to each of the patients and may store the medication information in a central storage location (e.g., memory 86).

Additionally, with respect to medications, the medical review module 78 may facilitate identifying and annotation of a patient's actual dosage of medication taken in an instance in which the actual dosage taken differs from the prescribed dosage of the medication. The annotation of the patient's actual dosage may be detected by the medical review module 78 in response to receipt of input by a user (e.g., a care manager, a health care professional, etc.) specifying the annotated data.

Moreover, the medical review module 78 may enable a user (e.g., a care manager (e.g., an individual(s) responsible for providing overall oversight of a patient's care)) to input medication information (e.g., medications taken, prescriptions, etc.) for one or more patients. For example, the user may be aware of one or more medications taken by a patient(s) that is not received from one of the different sources/entities. In this regard, the medical review module 78 may provide contextual validation to medical data. By combining manually entering data (e.g., medication data) with data (e.g., other items of medication data) received from one or more of the different external sources/entities, the medical review module 78 may provide a view (e.g., via a user interface) of medication information and clinical data corresponding to one or more patients for evaluation by a user (e.g., a care manager), as described more fully below.

In an example embodiment, the medical review module 78 may also provide the ability to flag data (e.g., medication data) for follow-up review. For example, there are many reasons that a user (e.g., a care manager, a health care professional, etc.) may desire to follow up with a prescribing provider (e.g., a physician) about a medication(s). In this regard, the medical review module 78 may enable the user (e.g., a care manager, a health care professional, etc.), via a generated user interface, to flag a medication for follow-up review, which may create a task for the user to remind the user to perform the follow-up review. The medical review module 78 may also prompt the user to indicate a follow-up reason which may be displayed in a follow-up task of a user interface.

The medical review module 78 may also create a user interface with the ability to view medication data based on a task(s) being performed. For a quick view of all medications respective patients are currently taking, the medical review module 78 may provide an ‘Active’ view in a user interface to view all the medications. For all medications requiring follow-up, the medical review module 78 may provide a follow-up view in a user interface. Additionally, the medical review module 78 may provide a history view via a user interface in an instance in which a complete view of all medications (e.g., current and past) is desired by a user (e.g., a care manager, a health care professional). The medical review module 78 may also provide a user (e.g., a care manager, a health care professional) the ability to further filter medication data (e.g., medication lists) to display specific medications based on criteria defined by the user.

Furthermore, the medical review module 78 may provide the ability to capture current clinical data (e.g., a current clinical data list (e.g., a medication list)) with detailed information about each medication, including, but not limited to, actual usage of a medication(s) versus the prescribed dosage of the medication(s) versus the actual filled dosage of the medication, as described more fully below. In this regard, the medical review module 78 may present this clinical data, via a user interface, in a comprehensive manner that may be easily shared.

In an example embodiment, the medical review module 78 may also provide the ability for a user (e.g., a care manager, a health care professional) to view clinical data, augment current clinical data, and/or add new clinical data to accurately represent a current state of one or more patients, as described more fully below. For instance, clinical data, including but not limited to, health issues (e.g., medical problems, medical diagnosis), immunizations, vitals, and any other suitable clinical data may be added to a record manually by a user (e.g., a care manager (e.g., a nurse)) and may be stored in a memory (e.g., memory 86) of a communication device (e.g., communication device 125). This clinical data may be arranged, by the medical review module 78, along with clinical data received (also referred to as ingested data) from one or more of the different sources/entities (e.g., medical entity 1, medical entity 7, pharmacy 3, pharmacy 11, laboratory 5, health care facility 9, etc.), and the specific data source (e.g., medical entity 1) may be viewable, via a user interface, which may indicate whether the clinical data was manually entered by a user (e.g., a care manager) or was received (e.g., via a data feed) from one or more of the different sources/entities.

In some example embodiments, the clinical data received (e.g., ingested data) from one or more of the different sources/entities may not be able to be changed by a user (e.g., a care manager). On the other hand, the medical review module 78 may augment the clinical data received with notes or annotations (e.g., a note or annotation indicating a need to confirm dosage information with a primary care provider (PCP)) and other statuses (e.g., a status such as “validated by care manager”, etc.) in response to receipt of input by a user. Additionally, in some alternative example embodiments, one or more items of clinical data received (e.g., medication information) from one or more of the different sources/entities may be changed (e.g., a change of a designated dosage of a medication based on a refill prescription) by a user.

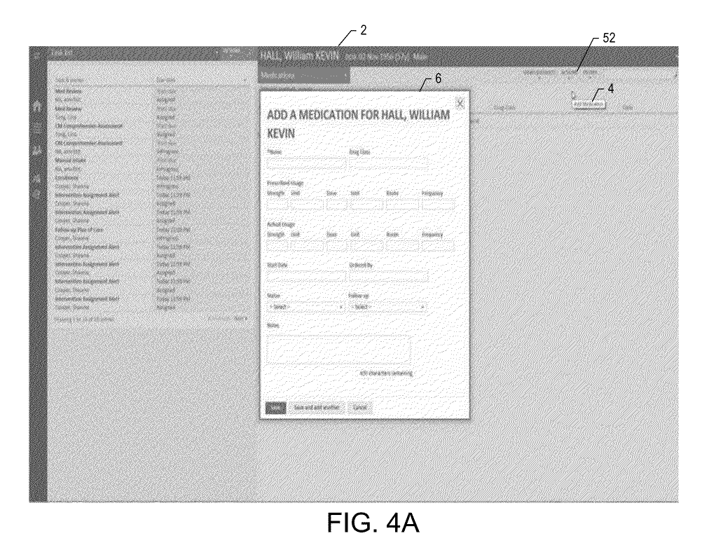

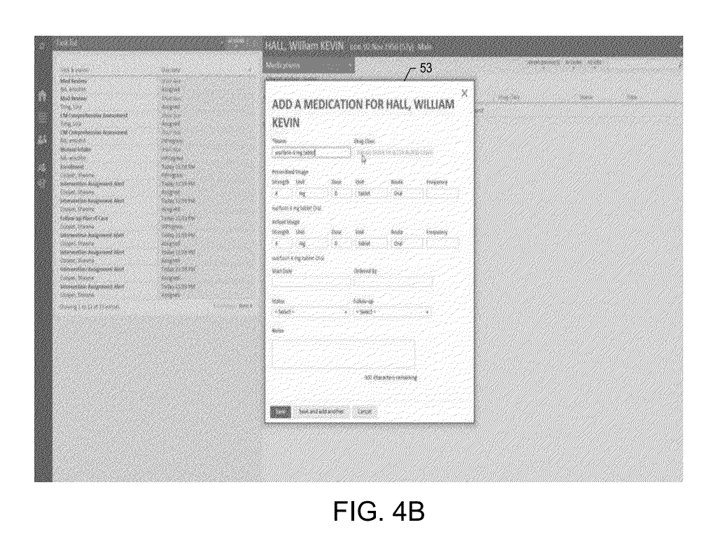

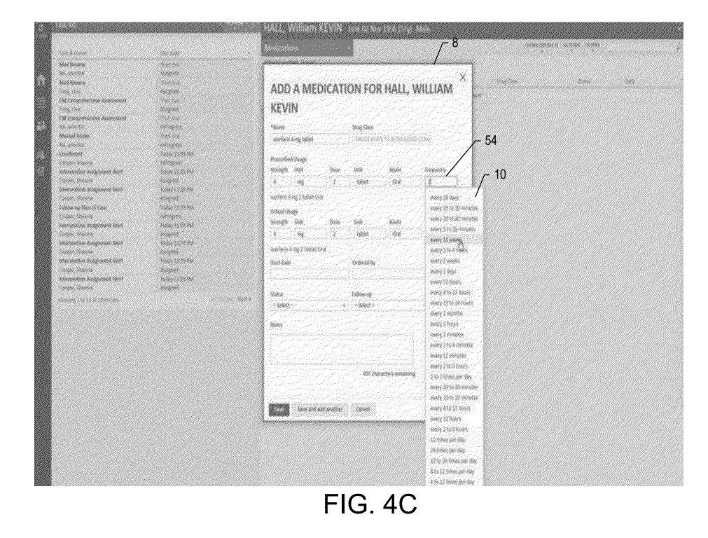

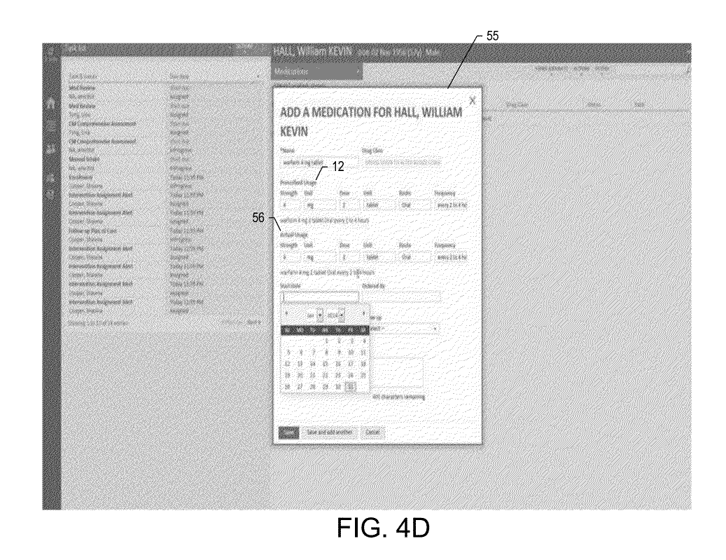

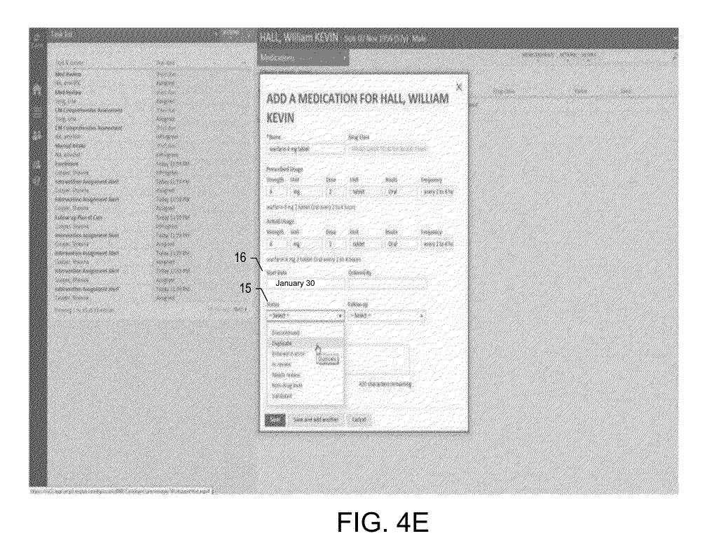

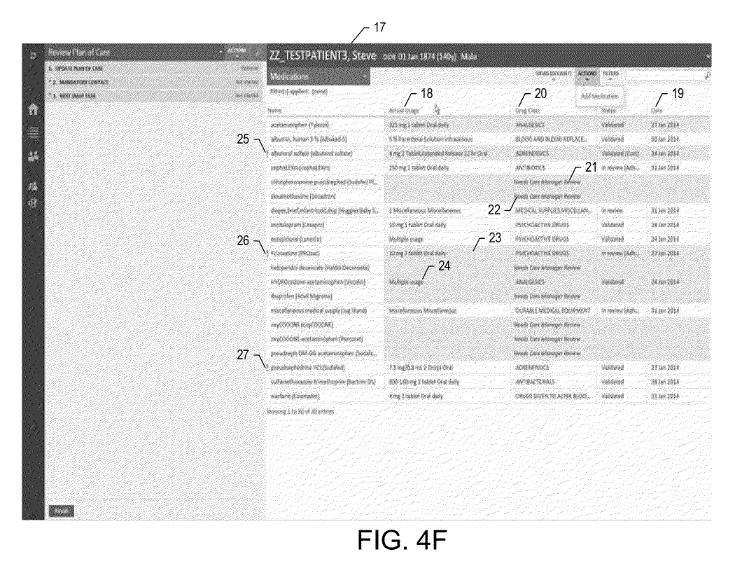

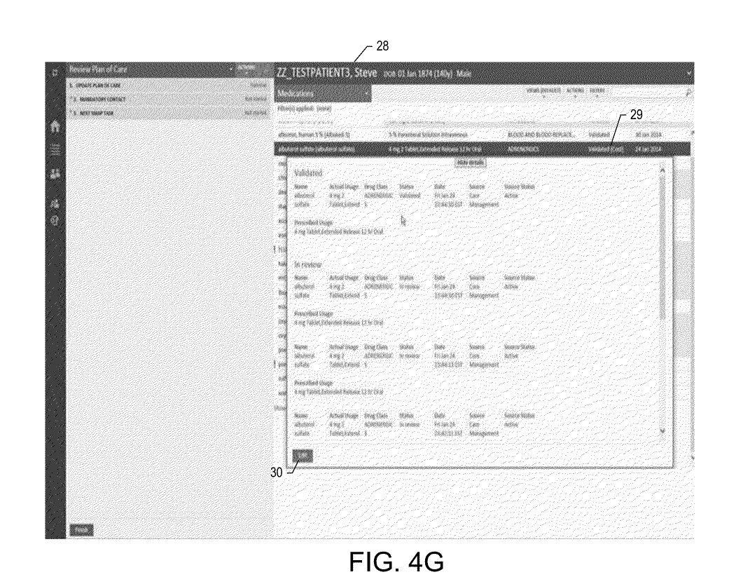

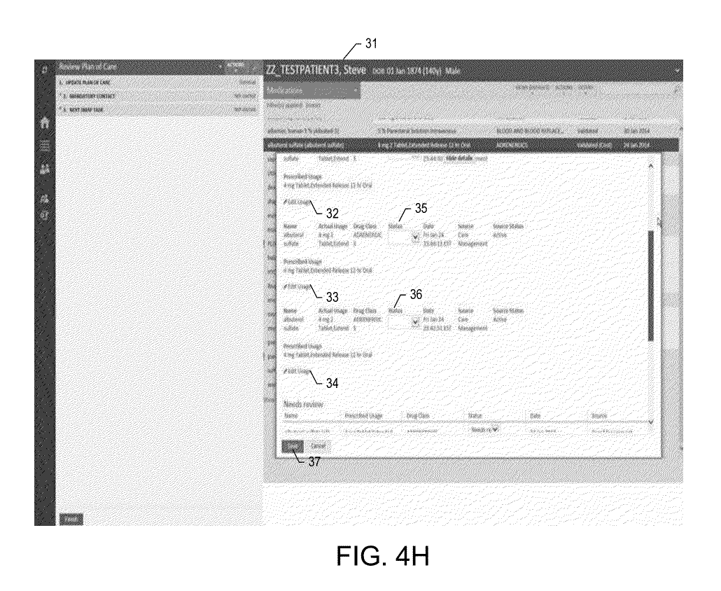

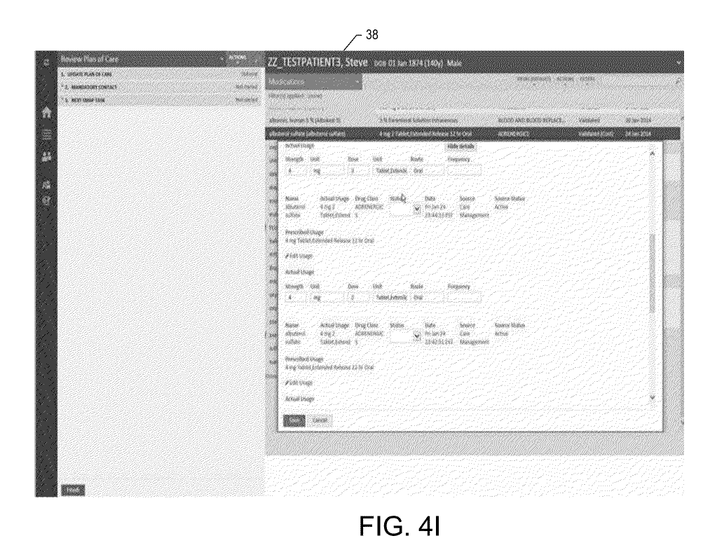

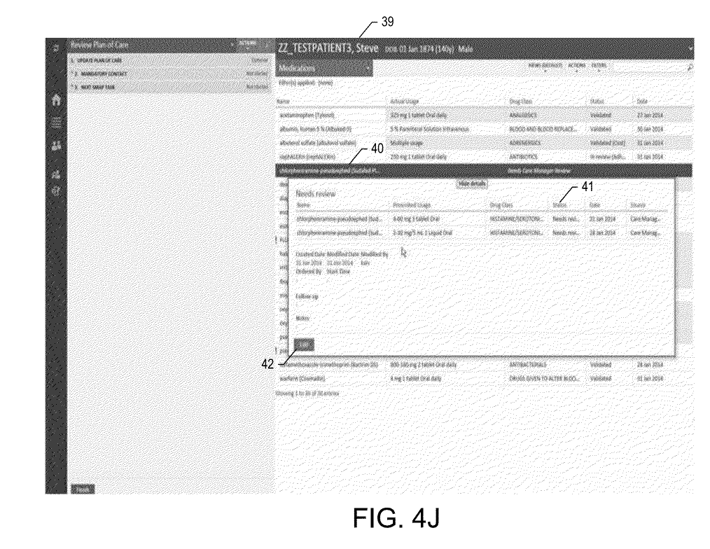

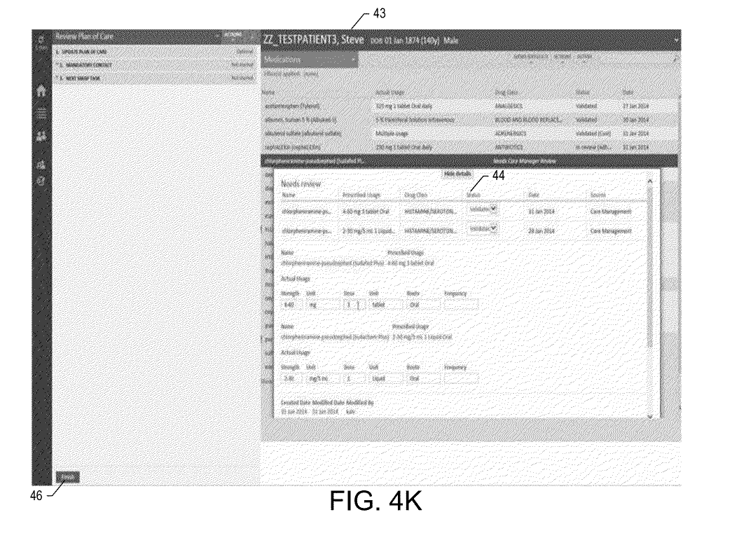

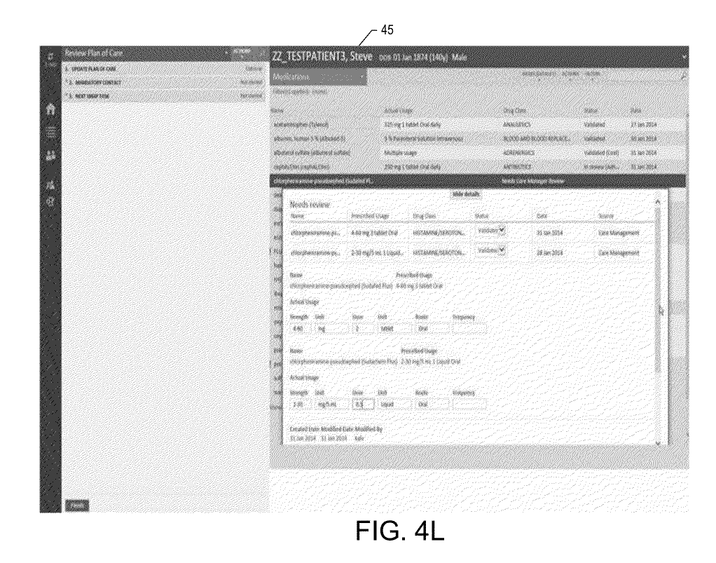

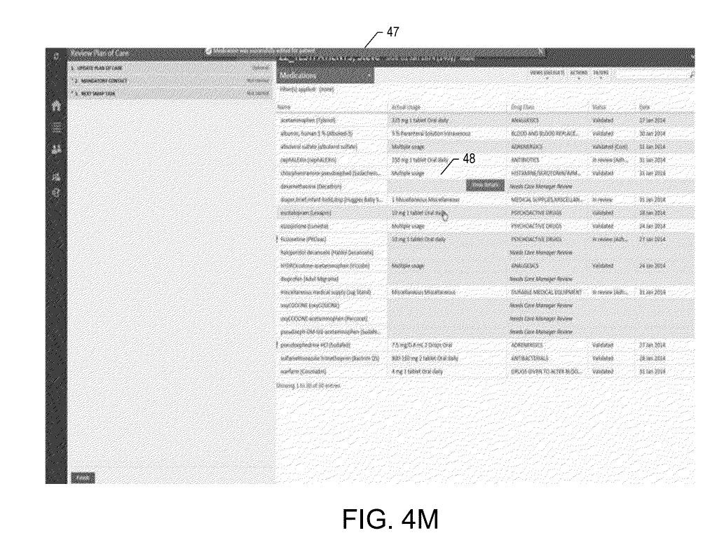

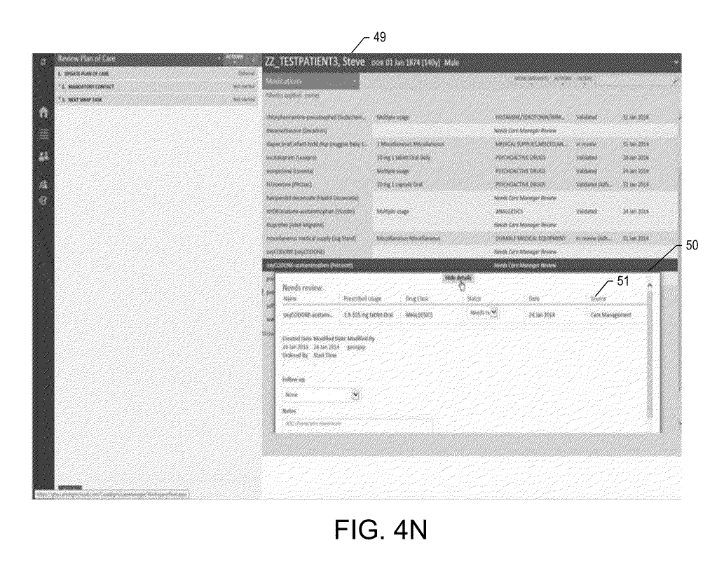

Referring now to FIGS. 4A-4N, diagrams illustrating user interfaces for managing clinical data according to example embodiments are provided. The medical review module 78 may generate the user interfaces of FIGS. 4A-4N, based in part on the clinical information (e.g., medication information) received from the different external sources/entities (e.g., medical entity 1, medical entity 7, pharmacy 3, pharmacy 11, laboratory 5, health care facility 9, etc.), and/or based on detection of input of data (e.g., annotation data) entered or specified by a user (e.g., a care manager), as described more fully below. In the example embodiment of FIGS. 4A-4N, the patients indicated in the user interfaces of FIGS. 4A-4N are fictitious individuals for purposes of illustration and not of limitation.

Referring to FIG. 4A, a diagram illustrating a user interface according to an example embodiment is provided. In the example embodiment of FIG. 4A, the medical review module 78 may generate the user interface 2 in response to receipt of an indication of a selection, by a user (e.g., a care manager), of an add medication field 4 associated with an actions tab 52. In this regard, medical review module 78 may manually add a medication to a list of medications of a patient(s) in response to receipt of an indication of input of the medication by a user via the user interface 6.

Referring to FIG. 4B, a user interface according an example embodiment is provided. In the example embodiment of FIG. 4B, in response to receipt of input of the name (e.g., warfarin) of the medication being input in user interface 53, the medical review module 78 may search a database (e.g., a medications database) stored in a memory (e.g., memory 86) and in response to detecting the name in the database, the medical review module 78 may auto populate other information (e.g., drug class) for selection in the user interface 53.

In the example embodiment of FIG. 4B, a user (e.g., a care manager (e.g., a nurse)) may call patient William Kevin Hall (e.g., a fictitious person) in the context of their care management tasks since there may not be any prior medications in a medications list for patient Hall. During the call, the user may ask patient Hall if he is taking a prescription of warfarin 4 mg each day and in the example embodiment of the FIG. 4B, patient Hall confirms that he is taking warfarin 4 mg every day.

As such, the user may input warfarin 4 mg tablet in the user interface 53 and in response to detection of the input, the medical review module 78 may add warfarin 4 mg to a list of medications for patient Hall. In the example embodiment of FIG. 4B since patient Hall confirmed that he is actually taking warfarin 4 mg each day as prescribed, the prescribed usage of warfarin matches the actual usage of warfarin in the user interface 53. Additionally, in the example embodiment of FIG. 4B, in response to detecting input of warfarin 4 mg, the medical review module 78 may auto populate other data such as, for example, an indication that warfarin is taken orally. However, the user (e.g., a care manager) may change the auto populated data as desired.

Referring to FIG. 4C, a diagram illustrating a user interface according to another example embodiment is provided. In the example embodiment of FIG. 4C, in response to receipt of an indication of input data such as, for example, the number 2 in frequency field 54 of the user interface 8, the medical review module 78 may provide visible indicia 10 indicating various options that include a frequency indicating the number 2 among other data (e.g., every 28 days, every 12 weeks, every 2 to 4 hours, etc.).

Referring to FIG. 4D, a diagram illustrating another user interface according to another example embodiment is provided. In the example embodiment of FIG. 4D, in response to receipt of an indication of a selection of the frequency information (e.g., every 2 to 4 hours) from the visible indicia 10 of FIG. 4C, the medical review module 78 may input the frequency information (e.g., every 2 to 4 hours) in a user interface 55 of FIG. 4D.

Additionally, in the example embodiment of FIG. 4D, in an instance in which prescription information indicating warfarin 4 mg, 2 tablets oral every 2 to 4 hours is input in the prescribed usage section 12 of the user interface 55, the medical review module 78 may auto populate this prescribed information in the actual usage section 56 of the user interface 55. However, in an instance in which a user (e.g., a care manager) calls the patient (e.g., patient Hall) and asks if the patient is taking the medication as prescribed and in an instance in which the patient indicates that they are not actually taking the medication as prescribed, the medical review module 78 may change the actual usage (e.g., a change to indicate a dosage of 1 tablet) in response to receipt of input by the user (e.g., a care manager). In this regard, the medical review module 78 is capable of determining the prescribed medication of the patient versus the medication actually taken by the patient.

Referring to FIG. 4E, a diagram illustrating another user interface according to another example embodiment is provided. In the example embodiment of FIG. 4E, in response to receipt of an indication of start date in which the patient (e.g., patient Hall) indicated that the patient began taking a medication, the medical review module 78 may include the start date (e.g., January 30th) in the state date field 16.

In the example embodiment of FIG. 4E, the status field 15 may include one or more statutes for selection, including but not limited to, discontinued, duplicate, entered in error, in review, needs review, non-drug item and validated. In this regard, for example, in response to receipt of an indication of a selection, by a user (e.g., a care manager), of the status validated from status field 15, the medical review module 78 may determine that the patient is actually taking a medication as the medication was prescribed. In other words, the indication of the status as validated may signify that the patient is taking their prescribed medication correctly. The in review status may denote that there is a problem with the manner in which the patient may be taking prescribed medication. Additionally, in an example embodiment, detection by the medical review module 78 of a selection of a follow-up reason in a follow-up dropdown menu may trigger a flag for follow-up to review the manner in which the medication is being taken by the patient (e.g., patient Hall) and to contact the patient again regarding the manner in which the medication is taken if needed.

The needs review status may denote that there is new clinical information (e.g., medication data (e.g., a newly prescribed medication)) for a patient (e.g., patient Hall) received via one or more of the different sources/entities (e.g., pharmacy 11) that a user (e.g., a care manager) may need to review.

Referring to FIG. 4F, a diagram illustrating another user interface according to another example embodiment is provided. In the example embodiment of FIG. 4F, the user interface 17 may be generated by the medical review module 78 and may include each of the medications, or other clinical data (e.g., immunizations, vitals, health issues (e.g., medical problems, medical diagnoses), etc.), automatically received from one or more of the different external source/entities (e.g., medical entity 1, the pharmacy 3, the laboratory 5, the medical entity 7, the health care facility 9 and the pharmacy 11, etc.) and clinical information (e.g., medication information, annotation information, etc.) detected as being input by a user (e.g. a care manager) for one or more respective patients (e.g., patient Steve of FIG. 4F). In the example embodiment of FIG. 4F, the medications may, but need not, be identified by generic name (e.g., acetaminophen) and the corresponding brand name may be in parentheses (e.g., Tylenol).

In addition to the name of the medications, the medical review module 78 may indicate the actual usage, in the actual usage column 18, of one or more of the medications by a patient (e.g., patient Steve) in the user interface 17. As described above, the actual usage of the medications may be detected in response to receipt of input by a user (e.g., a care manager) indicating whether the patient took the medication according to the manner in which the medication was actually prescribed. The medical review module 78 may also indicate the drug class of each of the medications in the user interface 17.

The medical review module 78 may also indicate the status (e.g., validated, in review, needs review, etc.) corresponding to the medications in the user interface 17. Additionally, the medical review module 78 may also indicate the date of the most recent adjustments made to a particular record corresponding to respective medications in the date column 19.

Moreover, the items (e.g., item 21, item 22) designated as “Needs Care Manager Review” indicated in the drug class column 20 of the user interface 17 may denote that the corresponding medications (e.g., Sudafed, Decadron) are detected, by the medical review module 78, as being newly received from one or more of the different sources or entities and may need to be reviewed by a user (e.g., a care manager). In other words, a user may not have reviewed the newly received medication information from the different sources/entities. In the example embodiment of FIG. 4F, in response to receipt of an indication of a selection of a status corresponding to a drug class designated as “Needs Care Manager Review” the medical review module 78 may provide details with data designating the status as “Needs Review”.

In an example embodiment, the medical review module 78 may include visible indicia (e.g., a color (e.g., yellow)) in the user interface 17 denoting to a user (e.g., a care manager) that there may be something new that the user may need to review. For example, the brand name medication Prozac, indicated as having an actual usage of 10 mg, 3 tablets, oral daily usage of a psychoactive drug class, may be highlighted with visible indicia 23 (e.g., a yellow color) which may denote to a user (e.g., a care manager), that although the user reviewed this medication (e.g., Prozac) previously and indicated the manner in which the corresponding patient is taking the medication there is something new for the user to review regarding the medication such as, for example, a new refill of the medication that may need to be reviewed by the user. The new refill information may be received from one or more of the different sources/entities (e.g., pharmacy 11).

Moreover, in the example embodiment of FIG. 4F, the medical review module 78 may indicate a designation (e.g., designation 24) of multiple usage as the actual usage for one or more medications. For example, regarding brand name Vicodin, the medical review module 78 indicated the actual usage as a multiple usage. The designation may indicate multiple usage since the patient (e.g., patient Steve) may take different prescribed amounts of the medication on different days. For purposes of illustration and not of limitation, the patient may take one pill of Vicodin every Monday and may take two pills of Vicodin every Tuesday.

The user may confirm that this actual usage of the medication corresponds to the manner in which the medication was prescribed and as such the medical review module 78 may detect a receipt of an indication by the user designating that the status is validated.

In addition, the medical review module 78 may include visible indicia (e.g., items of visible indicia 25, 26 and 27 (e.g., an exclamation point(s))) associated with the name of one or more medications (e.g., albuterol sulfate, Prozac, Sudafed) which may denote a flag to a user (e.g., a care manager (e.g., a nurse)) indicating that there is a difference between the manner in which the prescription was written for a corresponding patient and the manner in which the corresponding patient is actually taking the medication.

Referring to FIG. 4G, a diagram illustrating another user interface according to another example embodiment is provided. In the example embodiment of FIG. 4G, the medical review module 78 may generate the user interface 28 in response to receipt of an indication of a selection of albuterol sulfate in the user interface 17 of FIG. 4F. In this regard, the medical review module 78 may provide additional details corresponding to albuterol sulfate in the user interface 28.

In response to receipt of an indication of a selection of albuterol sulfate in the user interface 17, the medical review module 78 may include details of the multiple detected instances of albuterol sulfate in a window 29 which may be included in the user interface 28. As shown in the user interface 28, there are different statuses and different usages of medication albuterol sulfate.

For example, one of the statuses is designated as validated and another status is designated as in review. In particular, the first entry of the window 29 indicates a status of validated denoting that the actual usage of 4 mg, 2 tablets was actually used/taken by the patient (e.g., patient Steve) in the manner that the medication was prescribed.

The second entry of the window 29 indicates a status of in review denoting to a user (e.g., a care manager) to review the medication details or the manner in which the medication is being taken by the patient. For instance, the patient may not have been taking the medication, or may not have been taking the medication in the manner in which the medication was prescribed to be taken. As such, the patient's usage of the medication may need to be reviewed again. The details of the medication may need to be reviewed for any other suitable reasons (e.g., the cost of the medication) deemed relevant to a user (e.g., a care manager). In the example embodiment of FIG. 4G, the window 29 indicates that the medication albuterol sulfate is validated as to cost (e.g., “Validated (Cost)”). As such, in the example embodiment of FIG. 4G, the in review status may denote a flag to a user (e.g., a care manager) to review the cost of the medication since the medication associated with the in review status was utilized/taken by the patient in the manner that the medication was prescribed.

In response to receipt of an indication of a selection of the edit tab 30, the medical review module 78 may generate the user interface 31 of FIG. 4H. Based on receipt of an indication of an edit usage link(s) (e.g., edit usage links 32, 33, 34), associated with instances of the medication albuterol sulfate, the medical review module 78 may enable the corresponding usage and/or statuses to be changed as denoted by drop down arrows of the status boxes (e.g., status boxes 35, 36). As an example, for purposes of illustration and not of limitation, a user (e.g., a care manager) may select a status box to change a status in an instance in which the user determines that the patient is no longer taking 4 mg, 2 tablets of albuterol sulfate as prescribed and instead is taking 4 mg, 3 tablets of albuterol sulfate.

In response to receipt of an indication of a selection of the save tab 37, the medical review module 78 may save the usage and/or status changes of the user interface 31 and may generate the user interface 38 of FIG. 4I. For example in the example embodiment of FIG. 4I, the user interface 38 indicates that for the first entry of albuterol sulfate the patient is taking 3 doses/tablets of 4 mg albuterol sulfate, instead of the prescribed 2 doses/tablets of 4 mg albuterol sulfate.

Referring now to FIG. 4J, a diagram illustrating another user interface according to another example embodiment is provided. In the example embodiment of FIG. 4J, in response to selecting an item (e.g., item 21 of FIG. 4F) designated as “Needs Care Manager Review” of the user interface 17 of FIG. 4F, the medical review module 78 may generate the user interface 39.

In the user interface 39, the medical review module 78 may generate a window 40 indicating details of two items of medication information (e.g., prescribed usage of 4-60 mg 3 tablet oral, 2-30 mg/5 mL 1 liquid oral) corresponding to a medication such as, for example, Sudafed that is automatically received from one or more of the different sources or entities. In response to detecting receipt of the two items of medication information from one or more of the different sources or entities, the medical review module 78 may automatically assign the statuses of the two items of medication information as Needs review as indicated in the status column 41. By designating the statuses as Needs review, via the medical review module 78, the window 40 may denote that the two items of medication information corresponding to Sudafed have not yet been reviewed but needs review by a user (e.g., a care manager).

In response to receipt of an indication of a selection of the edit tab 42, the medical review module 78 may generate the user interface 43 of FIG. 4K. The user interface 39 illustrates that the status is changed from Needs review in the window 40 of user interface 39 of FIG. 4J to Validated in the user interface 43 of FIG. 4K. For example, in response to receipt of an indication from a user indicating that the patient (e.g., patient Steve) took two different doses of the medication Sudafed as prescribed, the medical review module 78 may detect a selection of the statuses of the two doses of the medication as validated as indicated in status column 44.

Referring now to FIG. 4L, a diagram illustrating another user interface according to another example embodiment is provided. In the example embodiment of FIG. 4L, the medical review module 78 may generate the user interface 45 which may indicate that the patient's actual usage of the two prescribed doses of Sudafed has changed such that the patient is no longer taking the two doses of Sudafed as prescribed. For instance, instead of taking the first dose as prescribed such as, for example, 4-60 mg, 3 tablets oral, the user interface 45 indicates receipt of input by a user (e.g., a care manager) specifying that the patient takes 4-60 mg, 2 tablets oral. Additionally, instead of taking the second dose as prescribed such as, for example, 2-30 mg/5 mL, 1 liquid oral, the user interface 45 indicates receipt of input by a user (e.g., a care manager) specifying that the patient takes 2-30 mg/5 mL, 0.5 liquid oral.

Referring now to FIG. 4M, a diagram illustrating another user interface according to another example embodiment is provided. In response to receipt of an indication of a selection of the Finish tab 46 of the user interface 43 of FIG. 4K, for example, the medical review module 78 may generate the user interface 47 of FIG. 4M. The user interface 47 may include visible indicia 48 indicating that the medication Sudafed has a multiple usage corresponding to two prescribed doses (e.g., 4-60 mg, 3 tablets orally, 2-30 mg/5 mL, 1 liquid orally) of the medication Sudafed and may denote that the status of the multiple usage is validated.

Referring now to FIG. 4N, a diagram illustrating another user interface according to another example embodiment is provided. In the example embodiment of FIG. 4N, the medical review module 78 may generate the user interface 49. The user interface 49 indicates a window 50 for a medication (e.g., oxycodone acetaminophen) that needs review which also provides visible indicia 51 indicating that the source of the information indicating the medication (e.g., oxycodone acetaminophen) is received from one of the different external sources or entities (e.g., health care facility 9) (also referred to herein as a care management source or as care management).

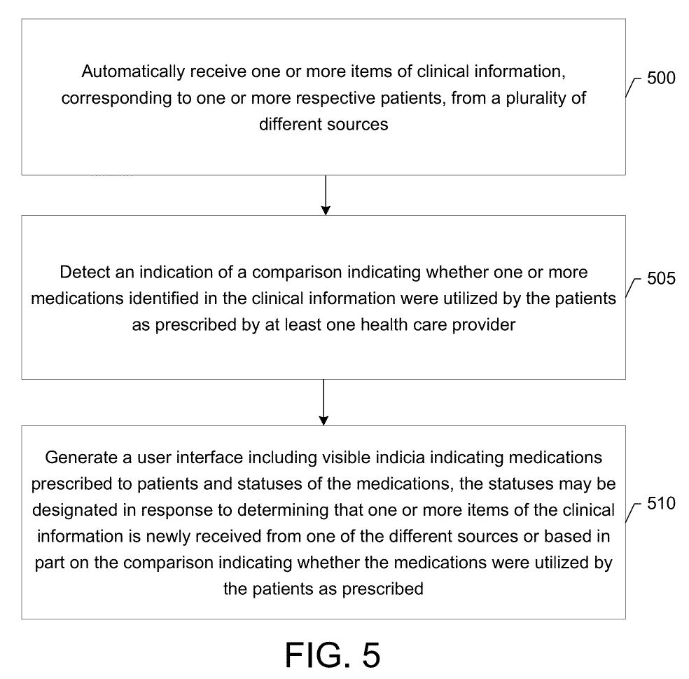

Referring now to FIG. 5, an exemplary method for managing clinical information is provided according to an exemplary embodiment. At operation 500, an apparatus (e.g., communication device 125) may include means, such as the medical review module 78, the clinical data manager 75, the processor 70 and/or the like, for automatically receiving one or more items of clinical information (e.g., medication information (e.g., prescription information), immunizations, vitals, health issues (e.g., medical problems, medical diagnoses)), corresponding to one or more respective patients (e.g., patient Hall, patient Steve, etc.), from a plurality of different sources (e.g., medical entity 1, pharmacy 3, laboratory 5, medical entity 7, health care facility 9, and/or pharmacy 11, etc.). At operation 505, the apparatus (e.g., communication device 125) may include means, such as the medical review module 78, the clinical data manager 75, the processor 70 and/or the like, for detecting an indication (e.g., detection of input specified by a user (e.g., a care manager)) of a comparison (e.g., a comparison of actual usage of a medication versus prescribed usage of the medication(s)) indicating whether one or more medications identified in the clinical information were utilized by the patients as prescribed by at least one health care provider (e.g. a physician(s), etc.).

At operation 510, the apparatus (e.g., communication device 125) may include means, such as the medical review module 78, the clinical data manager 75, the processor 70 and/or the like, for generating a user interface (e.g., user interface 17) including visible indicia indicating corresponding medications prescribed to respective patients (e.g., a list of medications prescribed for respective patients) and respective statuses (e.g., validated, in review, needs review, discontinued, duplicate, entered in error, non-drug item, etc.) of the corresponding medications. The statuses may be designated (e.g., selected) in response to determining that one or more respective items of the clinical information is newly received (e.g., newly received medication information of a patient(s)) from one of the different sources (e.g., medical entity 1) or based in part on the comparison indicating (e.g., detection of input comparing actual usage of a medication(s) with the prescribed usage of the medication(s)) whether the medications were utilized by the patients as prescribed.

It should be pointed out that FIG. 5 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, medical review module 78, clinical data manager 75). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 5 above may comprise a processor (e.g., the processor 70, the medical review module 78, the clinical data manager 75) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the medical review module 78, the clinical data manager 75 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
automatically receiving one or more items of clinical information, corresponding to one or more respective patients, from a plurality of different sources;
detecting an indication of a comparison indicating whether one or more medications identified in the clinical information were utilized by the patients as prescribed by at least one health care provider; and
generating, via a processor, a user interface comprising visible indicia indicating corresponding medications prescribed to respective patients and respective statuses of the corresponding medications, the statuses are designated in response to determining that one or more respective items of the clinical information is newly received from one of the different sources or based in part on the comparison indicating whether the medications were utilized by the patients as prescribed.

2. The method of claim 1, wherein the indication comprises detection of input by a user indicating whether the patients utilized the medications as prescribed.

3. The method of claim 1, wherein prior to generating the user interface, the method further comprises:
detecting input of one or more items of clinical data corresponding to one or more of the patients, the input being specified by a user, and
wherein generating the user interface further comprises additional visible indicia indicating the input of the items of the clinical data specified by the user, at least one of the items of clinical data comprises medication information corresponding to at least one of the patients.

4. The method of claim 1, further comprising:
designating at least one of the statuses as validated in response to detection of an indication specifying that a corresponding medication was utilized by a respective patient as prescribed.

5. The method of claim 1, further comprising:
designating at least one of the statuses as being in review in response to detection of an indication specifying that a corresponding medication was not utilized by a respective patient as prescribed or for a reason that a user desires to review the corresponding medication.

6. The method of claim 1, further comprising:
designating at least one of the statuses for review in response to detecting that a corresponding item of the clinical information is newly received from the different source, the status designated for review denotes that a medication indicated in the clinical information was not previously reviewed by a user.

7. The method of claim 1, further comprising:
generating additional visible indicia in the user interface denoting that at least one of the medications needs review in response to detection of an indication specifying that a respective medication was not utilized by a patient as prescribed.

8. The method of claim 7, wherein:
the additional visible indicia signifies at least one flag to remind a user to review the at least one medication.

9. The method of claim 1, further comprising:
changing at least one of the statuses in response to detection of another indication specifying that a respective medication is subsequently utilized by a corresponding patient different from a prior usage of the respective medication by the patient in comparison to usage of the respective medication as prescribed by the health care provider.

10. An apparatus comprising at least one processor and at least one memory including computer program code, the at least one memory and the computer program code configured to, with the processor, cause the apparatus to at least:
automatically receive one or more items of clinical information, corresponding to one or more respective patients, from a plurality of different sources;
detect an indication of a comparison indicating whether one or more medications identified in the clinical information were utilized by the patients as prescribed by at least one health care provider; and
generate a user interface comprising visible indicia indicating corresponding medications prescribed to respective patients and respective statuses of the corresponding medications, the statuses are designated in response to determining that one or more respective items of the clinical information is newly received from one of the different sources or based in part on the comparison indicating whether the medications were utilized by the patients as prescribed.

11. The apparatus of claim 10, wherein the memory and computer program code are further configured to, with the processor, cause the apparatus to:
detect the indication by detection of input by a user indicating whether the patients utilized the medications as prescribed.

12. The apparatus of claim 10, wherein prior to generate the user interface, the memory and computer program code are further configured to, with the processor, cause the apparatus to:
detect input of one or more items of clinical data corresponding to one or more of the patients, the input being specified by a user; and
generate the user interface by including additional visible indicia in the user interface indicating the input of the items of the clinical data specified by the user, at least one of the items of clinical data comprises medication information corresponding to at least one of the patients.

13. The apparatus of claim 10, wherein the memory and computer program code are further configured to, with the processor, cause the apparatus to:
designate at least one of the statuses as validated in response to detection of an indication specifying that a corresponding medication was utilized by a respective patient as prescribed.

14. The apparatus of claim 10, wherein the memory and computer program code are further configured to, with the processor, cause the apparatus to:
designate at least one of the statuses as being in review in response to detection of an indication specifying that a corresponding medication was not utilized by a respective patient as prescribed or for a reason that a user desires to review the corresponding medication.

15. The apparatus of claim 10, wherein the memory and computer program code are further configured to, with the processor, cause the apparatus to:
designate at least one of the statuses for review in response to detecting that a corresponding item of the clinical information is newly received from the different source, the status designated for review denotes that a medication indicated in the clinical information was not previously reviewed by a user.

16. The apparatus of claim 10, wherein the memory and computer program code are further configured to, with the processor, cause the apparatus to:
generate additional visible indicia in the user interface denoting that at least one of the medications needs review in response to detection of an indication specifying that a respective medication was not utilized by a patient as prescribed.

17. The apparatus of claim 16, wherein:
the additional visible indicia signifies at least one flag to remind a user to review the at least one medication.

18. The apparatus of claim 10, wherein the memory and computer program code are further configured to, with the processor, cause the apparatus to:
change at least one of the statuses in response to detection of another indication specifying that a respective medication is subsequently utilized by a corresponding patient different from a prior usage of the respective medication by the patient in comparison to usage of the respective medication as prescribed by the health care provider.

19. A computer program product comprising at least one non-transitory computer-readable storage medium having computer-executable program code instructions stored therein, the computer executable program code instructions comprising:
program code instructions configured to automatically receive one or more items of clinical information, corresponding to one or more respective patients, from a plurality of different sources;
program code instructions configured to detect an indication of a comparison indicating whether one or more medications identified in the clinical information were utilized by the patients as prescribed by at least one health care provider; and
program code instructions configured to generate a user interface comprising visible indicia indicating corresponding medications prescribed to respective patients and respective statuses of the corresponding medications, the statuses are designated in response to determining that one or more respective items of the clinical information is newly received from one of the different sources or based in part on the comparison indicating whether the medications were utilized by the patients as prescribed.

20. The computer program product of claim 19, further comprising:
program code instructions configured to detect the indication by detection of input by a user indicating whether the patients utilized the medications as prescribed.

21. The method of claim 1 wherein a first one of the received items of clinical information characterizes prescribed use of a distinguished medication by a distinguished one of the patients and a second one of the received items of clinical information characterizes actual use of the distinguished medication by the distinguished patient,
and wherein a distinguished indication is generated by comparing the first and second received items of clinical information.

22. The method of claim 1 wherein a first one of the received items of clinical information characterizes prescribed use of a distinguished medication by a distinguished one of the patients and a second one of the received items of clinical information characterizes pharmaceutical filling of the distinguished medication by the distinguished patient,
and wherein a distinguished indication is generated by comparing the first and second received items of clinical information.

23. The method of claim 1 wherein a first one of the received items of clinical information characterizes pharmaceutical filling of a distinguished medication by a distinguished one of the patients and a second one of the received items of clinical information characterizes actual use of the distinguished medication by the distinguished patient,
and wherein a distinguished indication is generated by comparing the first and second received items of clinical information.

24. The apparatus of claim 10 wherein a first one of the received items of clinical information characterizes prescribed use of a distinguished medication by a distinguished one of the patients and a second one of the received items of clinical information characterizes actual use of the distinguished medication by the distinguished patient,
and wherein a distinguished indication is generated by comparing the first and second received items of clinical information.

25. The apparatus of claim 10 wherein a first one of the received items of clinical information characterizes prescribed use of a distinguished medication by a distinguished one of the patients and a second one of the received items of clinical information characterizes pharmaceutical filling of the distinguished medication by the distinguished patient,
and wherein a distinguished indication is generated by comparing the first and second received items of clinical information.

26. The apparatus of claim 10 wherein a first one of the received items of clinical information characterizes pharmaceutical filling of a distinguished medication by a distinguished one of the patients and a second one of the received items of clinical information characterizes actual use of the distinguished medication by the distinguished patient,
and wherein a distinguished indication is generated by comparing the first and second received items of clinical information.

27. The computer program product of claim 19 wherein the program code instructions configured to automatically receive one or more items of clinical information are configured to automatically receive a first one of the received items of clinical information that characterizes prescribed use of a distinguished medication by a distinguished one of the patients and a second one of the received items of clinical information that characterizes actual use of the distinguished medication by the distinguished patient,
and wherein the program code instructions configured to detect an indication of a comparison indicating whether one or more medications identified in the clinical information were utilized by the patients as prescribed by at least one health care provider are configured to detect an indication generated by comparing the first and second received items of clinical information.

28. The computer program product of claim 19 wherein the program code instructions configured to automatically receive one or more items of clinical information are configured to automatically receive a first one of the received items of clinical information that characterizes prescribed use of a distinguished medication by a distinguished one of the patients and a second one of the received items of clinical information that characterizes pharmaceutical filling of the distinguished medication by the distinguished patient,
and wherein the program code instructions configured to detect an indication of a comparison indicating whether one or more medications identified in the clinical information were utilized by the patients as prescribed by at least one health care provider are configured to detect an indication generated by comparing the first and second received items of clinical information.

29. The computer program product of claim 19 wherein the program code instructions configured to automatically receive one or more items of clinical information are configured to automatically receive a first one of the received items of clinical information that characterizes pharmaceutical filling of a distinguished medication by a distinguished one of the patients and a second one of the received items of clinical information that characterizes actual use of the distinguished medication by the distinguished patient,
and wherein the program code instructions configured to detect an indication of a comparison indicating whether one or more medications identified in the clinical information were utilized by the patients as prescribed by at least one health care provider are configured to detect an indication generated by comparing the first and second received items of clinical information.
